(19) United States
(12) Patent Application Publication
(10) Pub. No.: US 2005/0105112 A1
(43) Pub. Date: May 19, 2005

(54) Printer calibration method, printer and recording material

(75) Inventor: Hiroshi Fukuda, Saitama (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 10/980,782

(22) Filed: Nov. 4, 2004

(30) Foreign Application Priority Data
Nov. 14, 2003 (JP) 2003-385580

(51) Int. Cl. G06F 15/00; H04N 1/46

(52) U.S. Cl. 358/1.9; 358/504

(57) ABSTRACT

Yellow reference patterns, magenta reference patterns and cyan reference patterns are printed as a gradation scale of each color on a leading end of a long web of color heat sensitive recording paper in the factory. Respective density grades of each color are indicated by density numbers. Yellow, magenta and cyan calibration patterns are printed by a color thermal printer to calibrate, at a constant density on the recording paper adjacently to the reference patterns of the corresponding colors. The user compares the calibration pattern of each color to the reference patterns of the corresponding color, to determine the density grade of the actual density of the calibration pattern. By entering the density number of the determined density grade for each color, the color thermal printer automatically corrects three color densities on the basis of the entered density numbers.

### FIELD OF THE INVENTION

The present invention relates to a printer calibration method for adjusting print densities of a printer. The present invention relates also to a printer that carries out calibration according to the method of the invention, and a recording material for use in the printer.

### BACKGROUND ARTS

Color heat sensitive recording paper has heat sensitive or thermosensitive coloring layers formed atop another on a base sheet. The heat sensitive coloring layers develop different colors from each other, e.g. cyan, magenta and yellow, as they are heated. The color heat sensitive recording paper and color thermal printers using the color heat sensitive recording paper have been produced and sold by the present applicant.

In the heat sensitive recording paper, the bottommost or innermost coloring layer, e.g. a cyan coloring layer, has the lowest heat sensitivity, and the upper coloring layer has the higher heat sensitivity. The topmost or outermost coloring layer, e.g. a yellow coloring layer, and intermediate coloring layers, e.g. a magenta coloring layer, are fixed when exposed to ultraviolet rays. The color thermal printer is provided with a thermal head that is pressed onto the heat sensitive recording paper to apply heat energy of different amounts, to make the thermosensitive coloring layers sequentially develop respective colors, and an optical fixation device for fixing the topmost and intermediate coloring layers, e.g. yellow and magenta coloring layers.

It is known in the art that the coloring characteristics of the heat sensitive recording paper change with the time, for example, as it is exposed to light for a period, or with a change in moisture retention. It is also known that the coloring density or gray-balance of the heat sensitive recording paper varies due to manufacture tolerances of the color thermal printer or due to variations in adjustment after the manufacture. For the sake of reducing the variations in color density and gray-balance, many calibration methods for the color thermal printers have been developed.

For example, a calibration method disclosed in Japanese Laid-open Patent Application No. 2001-058423 suggests making a sample print of calibration patterns by a color thermal printer that is to be calibrated, to measure the calibration patterns on the sample print by use of an internal or external densitometer. On the basis of measurement results, correction values are calculated for use in adjusting and correcting the color thermal printer.

In order not to waste the color heat sensitive recording paper by the calibration, a calibration method disclosed in Japanese Laid-open Patent Application No. 2001-239731 suggests printing calibration patterns on a leading end of a roll of long web of heat sensitive recording paper, since the leading end is to be cut and thrown away in any case. A calibration method disclosed in Japanese Laid-open Patent Application No. 2001-171231 suggests fixing the leading end of the recording paper roll in advance, to save time for printing calibration patterns.

There have also been known calibration methods that do not use any densitometer. In such calibration methods, the sample print made by the color thermal printer is compared with a reference print or color samples, to check variations in density and gray-balance by visual inspection. Then the color thermal printer is adjusted and corrected on the basis of the inspection results.

Because the calibration method using the densitometer needs the densitometer inside or outside the color thermal printer, the cost of calibration is raised by the cost of densitometer. In addition to that, because a space for incorporating the densitometer, or a space for measuring the sample print with the densitometer is necessary, the color thermal printers using the densitometer are greater in size, or need a bigger installation space.

On the contrary, the above mentioned problems do not come up in those calibration methods which do not use the densitometer.

However, because the color samples suffer aging-related changes, like fading, they are unstable as the calibration standards. Moreover, if the color samples are printed with different coloring materials or on different paper from the color heat sensitive recording paper, the colors look different depending upon the illumination light. Therefore, they are not reliable enough as the calibration standards.

Furthermore, since the visual inspection is largely dependent upon the experience of the inspector, it is difficult to achieve stable calibration.

### SUMMARY OF THE INVENTION

In view of the foregoing, a primary object of the present invention is to provide a calibration method for printers, which does not use a densitometer, but enables making reliable calibration with ease by the visual inspection.

Another object of the present invention is to provide a printer that can be calibrated with reliability without the need for any densitometer.

To achieve the above and other objects, according to the present invention, a calibration method for a printer comprises the steps of printing reference patterns previously on a recording material, the reference patterns representing a number of density grades; printing calibration patterns at a constant density on the recording material by a recording head of the printer; comparing the calibration patterns with the reference patterns, to select among from the reference patterns a density grade that is approximate to an actual density of the calibration pattern; and adjusting print densities of the recording head on the basis of a difference between a density value of the selected density grade and a set density value used for printing the calibration patterns.

According to a preferred embodiment, the calibration patterns are compared to the reference patterns through visual inspection, and data of the selected density grade is inputted in the printer. Then, the printer adjusts the print densities of the recording head automatically based on the input data.

The reference patterns are preferably printed in the same method as the calibration patterns by a reference printer or a marking device, which produces standard print densities.

A printer of the present invention comprises a recording head for printing images on a recording material; a head driver for driving the recording head based on printing data; a calibration data generator for outputting specified printing data to the head driver, for printing calibration patterns at a constant density adjacently to reference patterns, the reference patterns being previously printed on the recording material and representing a number of density grades; an input device for inputting data of one of the density grades that is selected as an approximate density to an actual density of the calibration patterns from among the reference patterns; and a density adjusting device for adjusting print densities of the recording head on the basis of the input data.

The density adjusting device preferably adjusts print densities of the recording head on the basis of a difference between an optical density value of the selected density grade and a set optical density value of the specified printing data generated from the calibration data generator.

A recording material of the present invention is characterized by having reference patterns previously printed outside an image recording area in which images are to be printed by a printer, the reference patterns representing a number of density grades.

According to a preferred embodiment, the recording material is a roll of a long web of recording material, and the reference patterns are printed on a leading end that is cut and thrown away after the printing in the image recording area.

According to the present invention, the calibration patterns are compared with the reference patterns that are previously printed on the recording material to represent a number of density grades, so that even an less experienced operator can determine the actual optical density of the printer with reliability.

Since the reference patterns are printed on the same recording paper in the same way as the calibration patterns, the colors of the reference patterns will not look different from those of the calibration patterns, independently of the illumination light. Therefore, the reference patterns serve as reliable color samples.

The print densities of the recording head are corrected on the basis of a difference between an optical density value of the actual density of each calibration pattern and the set value that is used for printing the calibration patterns. Therefore, there is no need for complicated calculations or operations. According to a preferred embodiment, the print densities are corrected automatically just by entering the density numbers, so anyone can make calibration of the color thermal printer without any difficulty.

As for a color printer that produces a full-color image by printing different colors on said recording material, the reference patterns and the calibration patterns are printed for each color, and compared color by color, to adjust print densities of the recording head color by color. Thereby, the gray balance is simultaneously corrected.

### BRIEF DESCRIPTION OF THE DRAWINGS

The above and other objects and advantages will become more apparent from the follow detailed description of the preferred embodiments when read in connection with the accompanying drawings, wherein like reference numerals designate like or corresponding parts throughout the several views, wherein:

FIG. 1 is a schematic diagram illustrating a color thermal printer according to an embodiment of the invention;

FIG. 2 is a fragmentary sectional view illustrating a layered structure of color heat sensitive recording paper;

FIG. 3 is a perspective view illustrating a roll of color heat sensitive recording paper having reference patterns printed on its leading end;

FIG. 4 is a top plan view of the color heat sensitive recording paper with the reference patterns printed thereon;

FIG. 5 is a top plan view of a sample print;

FIG. 6 is a block diagram illustrating a system controller of the color thermal printer of FIG. 1;

FIG. 7 is an explanatory diagram illustrating a density number input section of the color thermal printer;

FIG. 8 is a graph illustrating a relationship between density numbers and correction values;

FIG. 9 is a flowchart illustrating a sequence of calibration process; and

FIG. 10 is a flowchart illustrating a sequence of printing process.

### DETAILED DESCRIPTION OF THE PREFERRED EMBODIMENTS

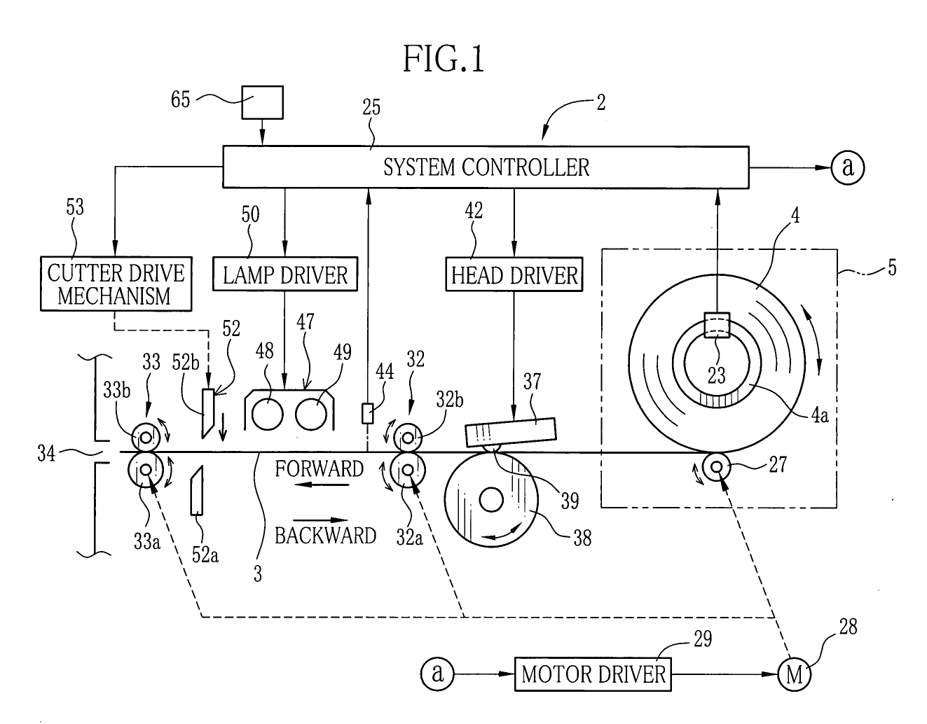

FIG. 1 shows a color thermal printer 2 according to an embodiment of the invention. The color thermal printer 2 uses a long web of color heat sensitive recording paper 3 as a recording material. The color heat sensitive recording paper 3 is sold as a recording paper roll 4 in the market, and the recording paper roll 4 is set in a roll chamber 5 of the color thermal printer 2.

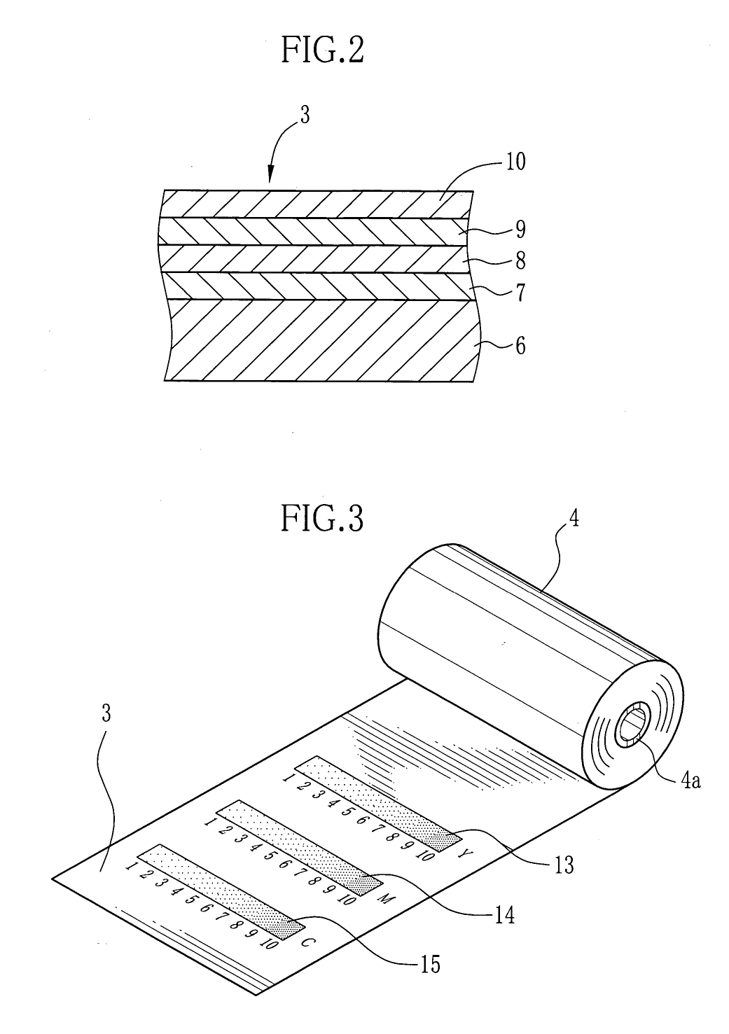

As shown in FIG. 2, the color heat sensitive recording paper 3 has three thermosensitive coloring layers for cyan, magenta and yellow 7, 8 and 9 which are formed atop another on a base sheet 6 in this order from the base sheet 6 toward a top protection layer 10. The topmost yellow coloring layer 9 has the highest heat sensitivity, so it develops yellow upon the smallest amount of heat energy among these coloring layers 7 to 9. The bottommost cyan coloring layer 7 has the lowest heat sensitivity, so it develops cyan with the largest amount of heat energy among these coloring layers 7 to 9. The yellow coloring layer 9 loses its coloring ability when exposed to near ultraviolet rays of 420 nm. The magenta coloring layer 8 colors magenta when it takes heat energy of an intermediate amount that is between the heat energy for the yellow coloring layer 9 and the heat energy for the cyan coloring layer 7. The magenta coloring layer 8 loses its coloring ability when exposed to ultraviolet rays of 365 nm. It is to be noted that there is color heat sensitive recording paper having four thermosensitive coloring layers, for example, a black coloring layer in addition to the cyan, magenta and yellow coloring layers. The present invention is applicable to those cases where the heat sensitive recording paper has four thermosensitive coloring layers.

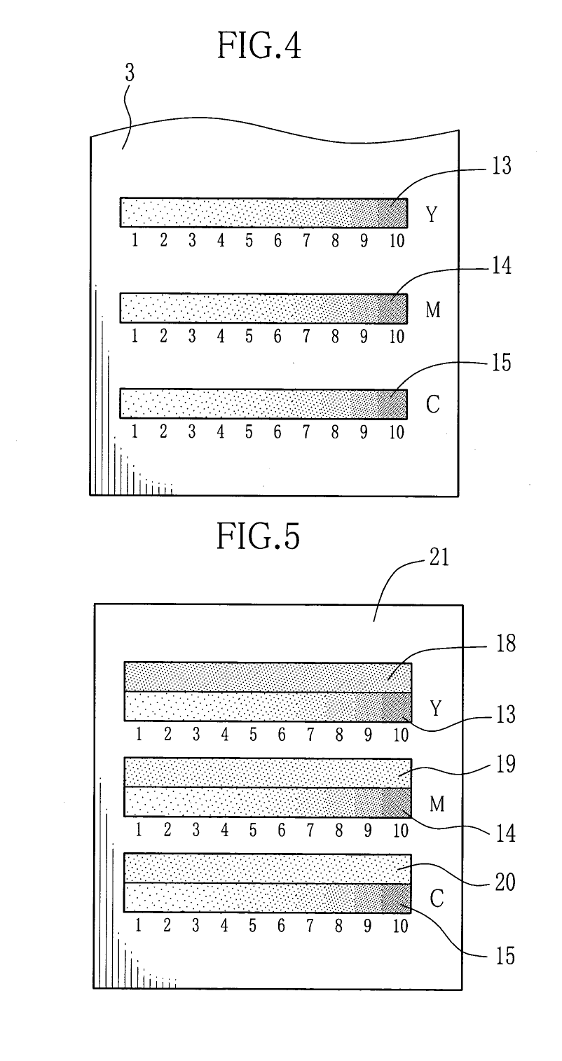

As shown in FIGS. 3 and 4, the color heat sensitive recording paper 3 has reference patterns 13, 14 and 15 for yellow (Y), magenta (M) and cyan (C) on a leading end of the recording paper roll 4. The reference patterns 13 to 15 are used as color samples for the calibration of the color thermal printer 2. The reference patterns 13 to 15 are printed for each color in a row that extends transversely to the color heat sensitive recording paper 3, and are arranged in three parallel rows. The reference patterns 13, 14 or 15 of each color are printed at different densities that increase gradually from the left to the right of each row in the drawings.

Numerals “1” to “10”, hereinafter referred to as density numbers, are printed along each of the reference patterns 13 to 15 in this order from the left end to the right end. The density numbers represent density grades at the respective positions of the individual reference patterns 13 to 15. So the reference patterns 13 to 15 serve as the scales of density gradation. The density numbers are not equal to optical density values. For example, in the reference patterns 13 for yellow, the position indicated by the density number “1” has a value of 0.3 in optical density (OD), the position designated by the density number “5” has a value of 0.5 in optical density, and the position designated by the density number “10” has a value of 0.7 in optical density.

The range of optical density in each of the reference patterns 13 to 15 is determined by the range of possible variations in print density in the color thermal printer 2. That is, the density ranges of the reference patterns 13 to 15 depend upon the design accuracy of the color thermal printer 2. Accordingly, for professional color thermal printers, as being designed to make highly accurate printing, the optical density range of the individual reference patterns can be narrow. On the other hand, for cheaper personal or home-type color thermal printers, the optical density range of the individual reference patterns get wider.

Most portion of the leading end of the color heat sensitive recording paper 3, on which the reference patterns 13 to 15 are printed, is out of an image recording area. That is, the leading end is not used for printing images, and is conventionally cut and thrown away on the printing. Accordingly, the whole length of the color heat sensitive recording paper 3 is fully utilized, and the number of prints available from the recording paper roll 4 is not remarkably reduced by printing the reference patterns 13 to 15. The reference patterns 13 to 15 are printed on the color heat sensitive recording paper 3 at the end of manufacture of the recording paper roll 4, by use of a reference thermal printer whose print density curves and gray-balance are used as standards for setting up print density curves and gray-balance of the color thermal printer 2.

As shown in FIG. 5, in the calibration process of the color thermal printer 2, calibration patterns 18, 19 and 20 for yellow, magenta and cyan are printed adjacently to the reference patterns 13 to 15 respectively, along an opposite side of each patterns from the associated density numbers. Thereafter, the leading end of the color heat sensitive recording paper 3 is cut off the recording paper roll 4, to be a sheet of sample print 21. The calibration patterns 18 to 20 are each printed at a uniform optical density by the color thermal printer 2 to calibrate. For example, the color thermal printer 2 is set to print the calibration patterns 18 to 20 at an optical density of 0.5.

In the calibration process, the user or operator compares the calibration patterns 18 to 20 with the reference patterns 13 to 15 respectively color by color, so as to determine which position of the individual reference patterns has an approximate density to an actual density of the calibration pattern of the corresponding color. Then the user determines the density number for each color, which indicates the position of the reference patterns having the approximate density to the density of the calibration pattern. If the color thermal printer 2 has the same print density curves for the three colors as the reference printer, the density number of any calibration pattern will be “5”. Therefore, the user can easily see if the three color densities printed by the color thermal printer 2 are higher or lower than those of the reference printer.

Since the reference patterns are printed on the same recording paper in the same way as the calibration patterns, the colors of the reference patterns will not look different from those of the calibration patterns, independently of the illumination light. Therefore, the reference patterns serve as reliable color samples. Because the reference patterns 13 to 15 serve as color gradation scales, and the calibration patterns 18 to 20 are printed to border the reference patterns 13 to 15 of the corresponding colors respectively, the reference pattern of each color looks linked to the corresponding calibration pattern at the position having the same density as the calibration pattern. Therefore, the density number indicating the position where the reference pattern is linked to the calibration pattern may be determined as the density number representative of the actual density of the calibration pattern. Thus, the user can easily determine the density numbers that represent the respective densities of the calibration patterns 18 to 20.

In order to serve as the color samples, the reference patterns 13 to 15 must be kept from being colored after they are printed by the reference printer. For this purpose, in the area where the yellow reference patterns 13 is printed, the yellow and magenta coloring layers 9 and 8 are fixed after the yellow reference patterns 13 is printed. Also in the area where the magenta reference patterns 14 is printed, the yellow coloring layer 9 is fixed before printing of the magenta reference patterns 14, and the magenta coloring layer 8 is fixed after the printing of the magenta reference patterns 14. In the area where the cyan reference patterns 15 is printed, the yellow and magenta coloring layers 9 and 8 are fixed before the cyan reference patterns 15 is printed. In this way, the reference printer prints the reference patterns 13 to 15 while making necessary fixative processes, but does not fix those areas where the calibration patterns 18 to 20 are to be printed.

Referring back to FIG. 1, the color thermal printer 2 has an optical sensor 23 in the roll chamber 5, in order to detect that the recording paper roll 4 is loaded in the roll chamber 5. The optical sensor 23 detects a rim of a spool 4a of the recording paper roll 4, and outputs a detection signal to the system controller 25.

A feed roller 27 is pressed on an outer periphery of the recording paper roll 4 in the roll chamber 5. The feed roller 27 is turned by a feed motor 28. The feed motor 28 is a pulse motor that is driven by pulses generated from a motor driver 29. As the feed roller 27 turns in a counterclockwise direction in the drawings, the recording paper roll 4 is turned in a clockwise direction in the drawings, so the color heat sensitive recording paper 3 is fed out from the recording paper roll 4. On the contrary, as the feed roller 27 turns in the clockwise direction, the recording paper roll 4 is turned in the counterclockwise direction, winding back the color heat sensitive recording paper 3.

A paper passageway extends horizontally from the roll chamber 5, so the color heat sensitive recording paper 3 is fed from the recording paper roll 4 through the paper passageway. A feed roller pair 32 and an ejection roller pair 33 are disposed in the paper passageway. The feed roller pair 32 and the ejection roller pair 33 consist of a capstan roller 32a or 33a and a pinch roller 32b or 33b. The capstan rollers 32a and 33a are turned by the feed motor 28, whereas the pinch rollers 32b and 33b are pressed against the capstan rollers 32a and 33a respectively. The color heat sensitive recording paper 3 is pinched between the pinch roller 32b or 33b and the capstan roller 32a or 33a, to be fed in a forward or feed out direction and a backward or wind-back direction, by turning the capstan roller 32a or 33a forwardly and reversely. A paper exit 34 is disposed at a position behind the ejection roller pair 33 in the forward direction, for ejecting the color heat sensitive recording paper 3 from the color thermal printer 2, after the color heat sensitive recording paper 3 has a full-color image printed thereon.

A thermal head 37 and a platen roller 38 are disposed across the paper passageway from each other in a position between the recording paper roll 4 and the feed roller pair 32. The thermal head 37 is placed above the paper passageway, and has a heating element array 39 on its bottom side. The heating element array 39 consists of a large number of heating elements aligned perpendicularly to the feeding direction or lengthwise direction of the color heat sensitive recording paper 3. One heating element is printing a pixel at a time, so that pixels are printed line by line as the color heat sensitive recording paper 3 is fed in the forward direction. The aligning direction of the heating element array 39 is called a main scan direction.

The platen roller 38 is placed below the paper passageway in opposition to the heating element array 39. The platen roller 38 is movable up and down by use of a not-shown shift mechanism that consists of cams or solenoids. In the upper position, the platen roller 38 is urged to be pressed against the thermal head 37 by a not-shown spring. The platen roller 38 is moved down by the shift mechanism, to be apart from the thermal head 37 while the color heat sensitive recording paper 3 is being initially fed toward the feed roller pair 32, while the color heat sensitive recording paper 3 is being fed in the backward direction, and while the color heat sensitive recording paper 3 is being ejected after each full-color image is printed.

While the color heat sensitive recording paper 3 is being fed in the forward direction by the feed roller pair 32, the color heat sensitive recording paper 3 is pinched between the heating element array 39 and the platen roller 38. The heating element array 39 is driven by a head driver 42 to heat the heating elements up to a temperature that is predetermined differently by the color, to make the coloring layers of the color heat sensitive recording paper 3 develop the individual colors in a sequential fashion. The platen roller 38 rotates along with the feeding movement of the color heat sensitive recording paper 3, so as to keep the color heat sensitive recording paper 3 in contact with the heating element array 39.

An optical sensor 44 is mounted in a position behind the feed roller pair 32 in the forward direction, so as to detect a leading edge of the color heat sensitive recording paper 3. A detection signal from the optical sensor 44 is sent to the system controller 25, and is used for controlling the color thermal printer 2.

An optical fixing device 47 is disposed behind the optical sensor 44 in the forward direction, above the paper passageway, that is, in face to a recording surface of the color heat sensitive recording paper 3. The recording surface is brought into contact with the heating element array 39. The optical fixing device 47 consists of a yellow fixing lamp 48 and a magenta fixing lamp 49. The yellowing fixing lamp 48 emits near-ultraviolet rays having an emission peak at 420 nm, for fixing the yellow coloring layer 9. The magenta fixing lamp 49 emits ultraviolet rays having an emission peak at 365 nm, for fixing the magenta coloring layer 8. These lamps 48 and 49 are driven to emit light by a lamp driver 50.

A cutter 52 is disposed between the optical fixing device 47 and the ejection roller pair 33, for cutting the color heat sensitive recording paper 3 perpendicularly to the lengthwise or feeding direction thereof. The cutter 52 has a stationary blade 52a that is fixedly mounted below the paper passageway, and a movable blade 52b that is movable up and down by a shutter drive mechanism 53. The color heat sensitive recording paper 3 is cut by being nipped between these blades 52a and 52b.

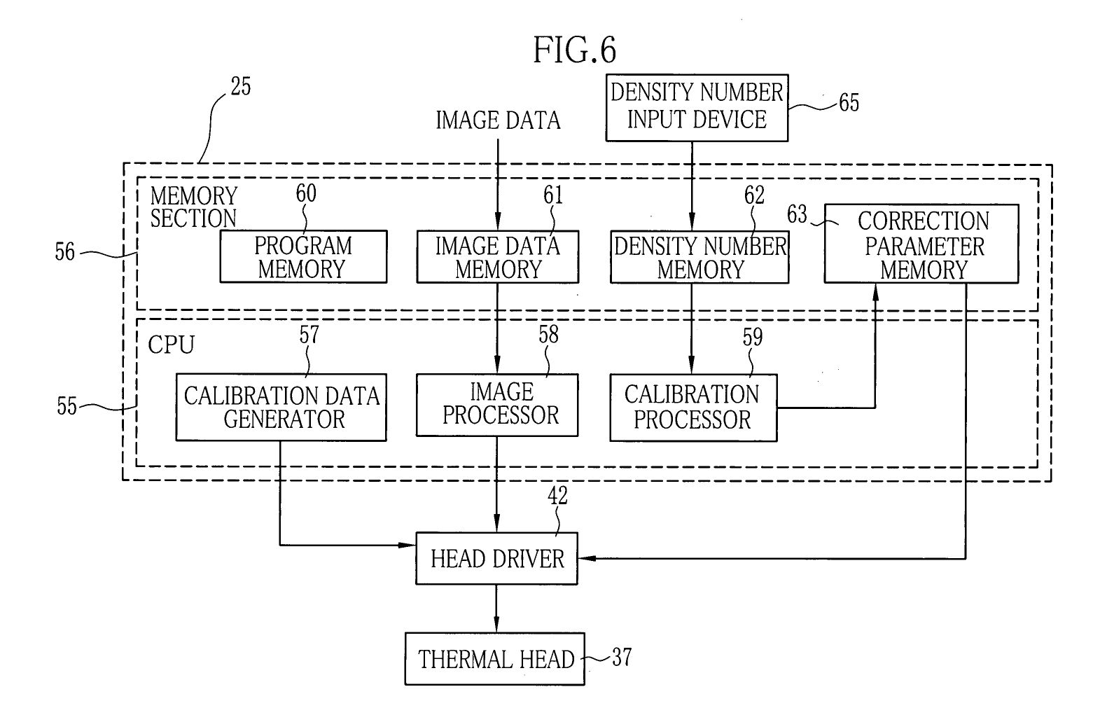

FIG. 6 shows a block diagram of the system controller 25 of the color thermal printer 2. The system controller 25 is constituted of a well-known microcomputer having a CPU 55 and a memory section 56, for making arithmetic operations necessary for controlling the color thermal printer 2. The CPU 55 is provided with a calibration data generator 57, an image processor 58, and a calibration processor 59. The memory section 56 is divided into several memory locations, and is provided with a program memory 60, an image data memory 61, a density number memory 62 and a correction parameter memory 63. The program memory 60 stores control programs for controlling the overall operation of the color thermal printer 2. The CPU 55 reads out the control programs at appropriate timing.

The image data memory 61 stores image data that are input from external apparatuses into the color thermal printer 2. The image data stored in the image data memory 61 is read out by the image processor 58. The image processor 58 processes the image data for correcting color and gradation in a conventional manner, and then converts the image data into printing data that are adapted for driving the thermal head 37. The printing data are sent to the head driver 42. On the basis of the printing data, the head driver 42 controls the length of conduction time of each individual heating element, for which the heating element is made conductive. As a result, pixels printed on the color heat sensitive recording paper 3 have different densities in accordance with the printing data.

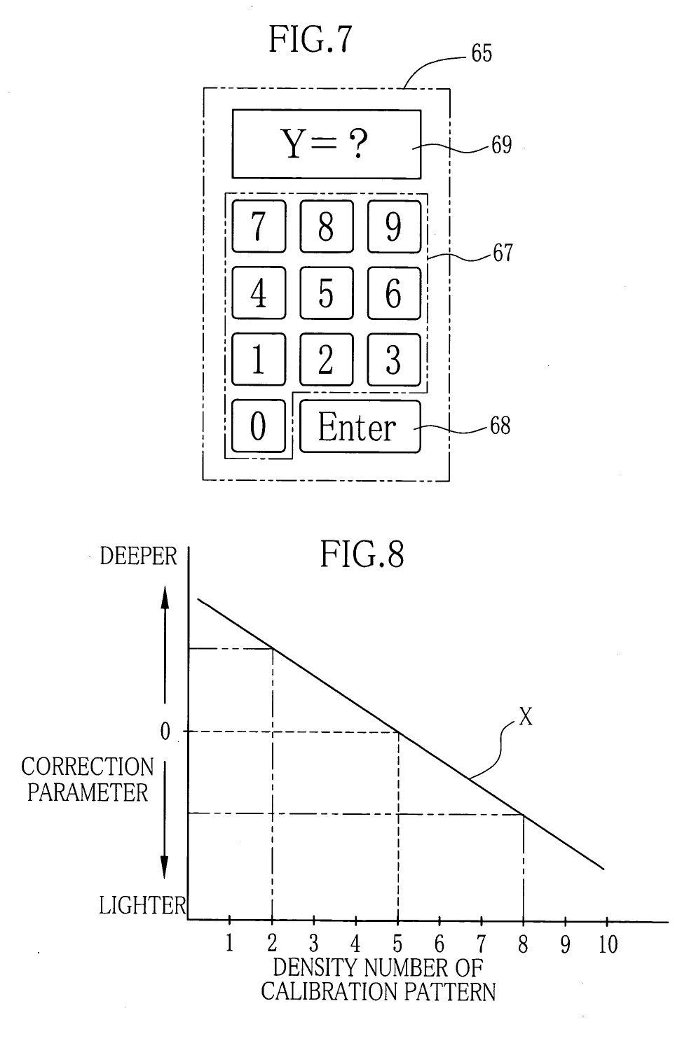

The density number memory 62 stores three density numbers for the three colors, which are entered through a density number input device 65 in the calibration process, as will be described in detail later. As shown for example in FIG. 7, the density number input device 65 is constituted of numeric keypads 67 from “0” to “9”, an Enter key 68 for concluding the data entry, and a liquid crystal display (LCD) 69 for displaying the content being entered. The density number input device 65 is disposed outside the color thermal printer 2, or in a position that is hidden during the ordinary printing, but is easy to access for the calibration process.

On the calibration process, the LCD 69 displays a message requiring entry of the density numbers. For example, the LCD 69 displays “Y=?”, as shown in FIG. 7, which asks the user to enter the density number for yellow. As described above, the user compares the yellow reference patterns 13 to the yellow calibration pattern 18, to find out the same density position in the yellow reference patterns 13 as the density of the yellow calibration pattern 18. Then, the user inputs the density number representative of the density of the yellow calibration pattern 18 by operating the numeric keypads 67.

When the entry of the density number for yellow is concluded by pressing the Enter key 68, the LCD 69 displays a message “M=?” asking the user to enter a density number that represents the density of the magenta calibration pattern 19.

Then, the user enters the density number for magenta in the same way as described with respect to the density number for yellow. Thereafter, the density number for cyan is entered in the same way as for the yellow and magenta.

In a case where the calibration process is unnecessary, namely the density number of any calibration pattern is “5” in the present example, it is desirable to terminate the calibration process, so as immediately to start ordinary printing. For this purpose, it is preferable to provide the density number input device 65 with a cancel button or the like that permits terminating the calibration process at any time. The calibration process may also be terminated when the density number input device 65 has not been operated for a predetermined time.

The calibration data generator 57 is activated when the recording paper roll 4 is loaded in the recording paper roll 4, to output calibration printing data to the head driver 42, for printing the calibration patterns 18 to 20. The head driver 42 drives the heating elements of the thermal head 37 on the basis of the calibration printing data, to print the calibration patterns 18 to 20 adjacently to the reference patterns 13 to 15 respectively.

The calibration processor 59 calculates correction parameters for yellow, magenta and cyan on the basis of the density numbers for the three colors, which are read out from the density number memory 62. The conduction time of each individual heating element is corrected with the correction parameter for yellow while the head driver 42 is driving the heating elements in accordance with the printing data for yellow. In the same way, the conduction time of each individual heating element is corrected with the correction parameter for magenta during the printing of magenta, and with the correction parameter for cyan during the cyan printing. The correction parameters for yellow, magenta and cyan are stored in the correction parameter memory 63, and are read by the head driver 42 on printing the respective colors.

FIG. 8 shows a graph illustrating the method of calculating the correction parameters by the calibration processor 59. In this graph, the longitudinal axis represents correction parameters, and the transverse axis represents density numbers, whereas a straight line X represents a density correction characteristic curve. As described above, in the calibration process, the calibration patterns 18 to 20 are printed on the color heat sensitive recording paper 3 so as to have the set optical density of 0.5. If the calibration patterns 18 to 20 actually have the optical density of 0.5, the density of any calibration patterns 18, 19 or 20 is equal to the density that is located close to the density number “5” in the corresponding reference patterns 13, 14 or 15. According to the density correction curve X as shown in FIG. 8, the correction parameter is zero when the density number is “5”, so it is unnecessary to correct print densities of the color thermal printer 2.

On the other hand, if the density number of any of the calibration patterns 18 to 20 is determined to be “2”, the actual optical density of that calibration pattern is around 0.3. Therefore, the print density of the color thermal printer 2 is lower than the set value, i.e. the optical density of 0.5.

Accordingly, as shown in FIG. 8, a correction parameter for making the print density deeper is obtained by the calculation based on the density number “2”. On the contrary, if the density number of any of the calibration patterns 18 to 20 is determined to be “8”, the actual optical density of that calibration pattern is around 0.6. Therefore, the print density of the color thermal printer 2 is higher than the set value. In that case, the obtained correction parameter will be a value for making the print densities lighter.

In this way, the correction parameters are calculated on the basis of a difference between an optical density value of the actual density of each calibration pattern 18, 19 or 20, which is indicated by the density number selected with reference to the reference pattern of each color 13, 14 or 15, and the set value, i.e. the optical density of 0.5 in this embodiment, that is used for printing the calibration patterns 18 to 20. Therefore, there is no need for complicated calculations or operations, so that it is possible to obtain the correction parameters speedily even with an inexpensive low-capacity system controller. Since the print densities are corrected automatically just by entering the density numbers approximate to the actual densities of the calibration patterns of the respective colors, the calibration method of the present invention allows anyone to make calibration of the color thermal printer.

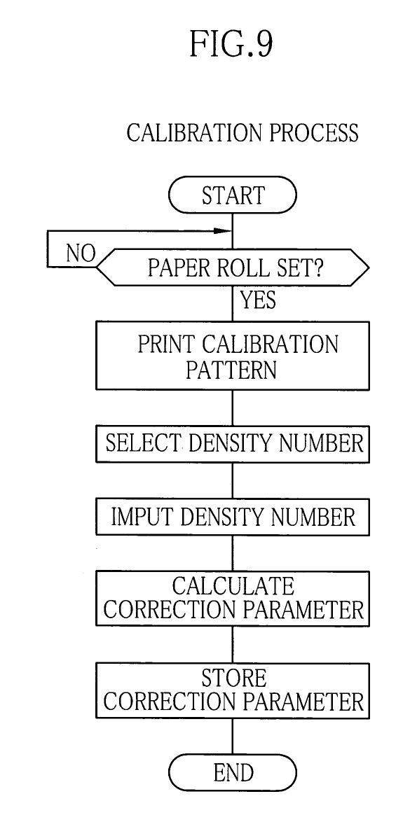

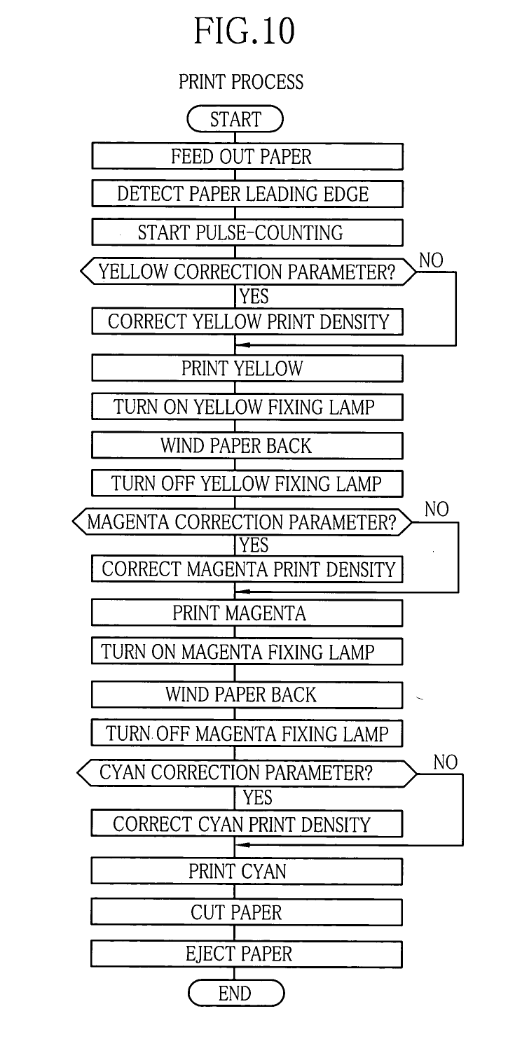

Now the operation of the color thermal printer 2 will be described with reference to the flowcharts shown in FIGS. 9 and 10. In order to use it, the color thermal printer 2 needs loading the recording paper roll 4. First, the recording paper roll 4 is taken out of a light-tight moisture-proof bag.

The recording paper roll 4 has the reference patterns 13 to 15 for yellow, magenta and cyan, which are previously printed on the leading end of the color heat sensitive recording paper 3 by the reference printer, as shown in FIGS. 3 and 4. Next, a lid of the roll chamber 5 of the color thermal printer 2 is opened to set the recording paper roll 4 in the roll chamber 5. Thereafter when the lid is closed, the optical sensor 23 is activated.

The optical sensor 23 detects the rim of the spool 4a of the recording paper roll 4, and outputs a detection signal to the system controller 25. When the CPU 55 of the system controller 25 recognizes by the detection signal from the optical sensor 23 that the recording paper roll 4 is newly loaded in the roll chamber 5, the CPU 55 starts the calibration process. In this way, the calibration process starts automatically each time the recording paper roll 4 is newly loaded. So the three color densities and the gray balance of the color thermal printer 2 are maintained in proper values. According to this method, besides density errors caused by the printer itself, such density errors that may be resulted from the coloring characteristics of the color heat sensitive recording paper 3 are corrected as well.

The system controller 25 drives the feed motor 28 through the motor driver 29, to turn it forwardly for feeding the color heat sensitive recording paper 3 from the recording paper roll 4 into the paper passageway. The leading end of the color heat sensitive recording paper 3 is fed through the paper passageway to the feed roller pair 32, and is nipped between the rollers 32a and 32b. Then, the color heat sensitive recording paper 3 is fed further in the forward direction. When the leading edge of the color heat sensitive recording paper 3 is detected by the optical sensor 44, the system controller 25 starts counting the number of pulses applied to the feed motor 28. The count value is used for determining the position of the color heat sensitive recording paper 3 in the paper passageway by the system controller 25.

When the color heat sensitive recording paper 3 comes to a position for starting printing the yellow calibration pattern 18 is in a printing position of the thermal head 37, the feed motor 28 stops rotating. Then, the platen roller 38 is moved up by the shift mechanism, to nip the color heat sensitive recording paper 3 between the heating element array 39 and the platen roller 38.

The calibration data generator 57 outputs calibration printing data to the head driver 42, for printing the yellow calibration pattern 18 at the set optical density of 0.5. Then the feed motor 28 restarts rotating forwardly, to feed the color heat sensitive recording paper 3 in the forward direction. While the color heat sensitive recording paper 3 is being fed in the forward direction, the heating element array 39 is heated according to the calibration printing data for yellow, so that the yellow calibration pattern 18 is printed adjacently to the yellow reference patterns 13.

If the correction parameter memory 63 already stores a correction parameter for yellow that is obtained in a previous calibration process, the print density of the yellow calibration pattern is corrected on the basis of the correction parameter read out from the correction parameter memory 63.

Thus, the calibration is carried out with respect to the print density that has been used before the present calibration process.

When the yellow calibration pattern 18 reaches a position that faces to the yellow fixing lamp 48 of the optical fixing device 47, the feed motor 28 stops. Then, the platen roller 38 is moved down by the shift mechanism, to be apart from the thermal head 37. Next, the yellow fixing lamp 48 is turned on while the feed motor 28 is rotating reversely to feed the color heat sensitive recording paper 3 in the backward direction. Thereby, the yellow coloring layer 9 is fixed in the leading end of the color heat sensitive recording paper 3.

After the yellow coloring layer 9 is completely fixed in the leading end of the color heat sensitive recording paper 3, and a print starting position for the magenta calibration pattern 19 comes to the printing position of the thermal head 37, the feed motor 28 stops rotating for a moment. After the platen roller 38 moves up to nip the color heat sensitive recording paper 3 between the heating element array 39 and the platen roller 38, the feed motor 28 restarts rotating forwardly, to feed the color heat sensitive recording paper 3 in the forward direction.

In the same way as for the yellow calibration pattern 18, the magenta calibration pattern 19 is printed adjacently to the magenta reference patterns 14 of the color heat sensitive recording paper 3, so as to have the optical density of 0.5.

If the correction parameter memory 63 already stores a correction parameter for magenta, the print density of the magenta calibration pattern is corrected on the basis of the previously stored correction parameter.

After the magenta calibration pattern 19 is printed, the magenta coloring layer 8 is fixed by the magenta fixing lamp 49 while the color heat sensitive recording paper 3 is being fed in the reverse direction. After the magenta coloring layer 8 is fixed in the leading end of the color heat sensitive recording paper 3, the cyan calibration pattern 20 is printed adjacently to the cyan reference patterns 15, so as to have the optical density of 0.5, in the same way as for the yellow and magenta calibration patterns 18 and 19. If a correction parameter for cyan is already stored, the print density of the cyan calibration pattern 20 is corrected with this correction parameter.

The leading end of the color heat sensitive recording paper 3, as having the reference patterns 13 to 15 and the calibration patterns 18 to 20 printed thereon, is cut by the cutter 52, into a sheet of sample print 21. The ejection roller pair 33 ejects the sample print 21 through the paper exit 34 out of the color thermal printer 2.

The user observes the sample print 21, to select such a density number for each color from the individual reference patterns 13, 14 or 15, which indicates the same or like density as the actual density of the calibration pattern 18, 19 or 20 of the corresponding color. Since the reference patterns 13 to 15 are printed on the same recording paper in the same way as the calibration patterns, the color tinges of the reference patterns will not look different from those of the calibration patterns, independently of the illumination light.

Because the reference patterns 13 to 15 serve as density gradation scales, and the calibration patterns 18 to 20 are printed adjacently to the reference patterns 13 to 15 respectively color by color, it is easy to determine the density number corresponding to the density of the individual calibration pattern.

Take a case for example, where the yellow calibration pattern 18 has a density that is indicated by the density number “8”, and the magenta and cyan calibration patterns 19 and 20 have densities indicated by the density number “5”.

In this case, magenta and cyan optical densities of the color thermal printer 2 are equal to those of the reference printer, but yellow optical density of the color thermal printer 2 is higher than that of the reference printer. If any of the three color optical densities is at variance, the gray-balance of the color thermal printer 2 becomes improper.

As shown in FIG. 7, the density number input device 65 displays the message “Y=?” on the LCD 69.

Then, the user enters the density number “8” by operating the numeric keypad 67, and concludes the data entry by pressing the Enter key 68.

Then the LCD 69 displays the message “M=?”, so the density number “5” is entered in the same way as for yellow. At last, the LCD 69 displays a message asking the entry of the density number for cyan, so the density number for cyan is entered.

The density numbers for the three colors, which are entered through the density number input device 65, are stored in the density number memory 62. The calibration processor 59 reads out the density numbers for the three colors from the density number memory 62, to calculate correction parameters for the respective colors according to the characteristic curve shown in FIG. 8. For example, the print density for yellow, as indicated by the density number “8”, is too high as compared to the standard value of the reference printer. Accordingly, a yellow correction parameter for making the yellow print density lower or lighter is calculated, and stored in the correction parameter memory 63.

On the other hand, since the density numbers for magenta and cyan are “5”, and it means that the magenta print density and the cyan print density of the color thermal printer 2 are approximately equal to those of the reference printer, there is no need for correcting magenta and yellow densities. Therefore, the calibration processor 59 calculates neither a magenta correction parameter nor a cyan correction parameter.

In that case, if the correction parameter memory 63 already stores a magenta correction parameter or a cyan correction parameter, which is obtained and used in a past calibration, the previous magenta or cyan correction parameter is kept stored.

As described so far, because the print densities are corrected automatically just by entering the density numbers, anyone can make calibration of the color thermal printer 2 without any difficulty. Furthermore, because the correction parameters are calculated on the basis of the density numbers, even an inexpensive low-capacity system controller can speedily obtain the correction parameters.

When the calibration process is finished, the color thermal printer 2 gets into a print standby position. When the printing process is started from this condition, the color thermal printer 2 controls the head driver 42 during the yellow printing, to shorten the conduction time of each heating element by an amount defined by the yellow correction parameter that is read out from the correction parameter memory 63. As a result, the print density of the yellow image is lowered to a level that is equivalent to the print densities of the magenta and cyan images. Consequently, the three color densities of the color thermal printer 2 are equalized to those of the reference printer, so the gray-balance is corrected.

Although the reference patterns are printed by the reference printer in the above embodiment, it is possible to use a marking device to print the reference patterns on the color heat sensitive recording paper. The calibration patterns are not necessarily printed to border the corresponding reference patterns, but may be printed apart from the reference patterns. Although the reference patterns of each color are printed as a gradation scale in the above embodiment, the reference patterns of each color may consist of separate segments having different optical densities from one another.

Although the present invention has been described with respect to the color thermal printer that uses the recording paper roll, the present invention is applicable to those color thermal printers that use cut sheet papers.

In the above embodiment, the calibration process is carried out when the recording paper roll is newly set in the printer. However, it is possible to design the printer such that the calibration process can be carried out at any appropriate time.

Although the above embodiment has been described with respect to the color thermal printer, the present invention is applicable to thermal printers capable of printing monochrome images only.

Moreover, the present invention is applicable not only to thermal printers using heat sensitive recording paper, but also to other types of color and monochrome printers.

Thus the present invention is not to be limited to the above embodiments but, on the contrary, various modifications will be possible without departing from the scope and spirit of appended claims.

1. A calibration method for a printer comprising the steps of:
printing reference patterns previously on a recording material, said reference patterns representing a number of density grades;
printing calibration patterns at a constant density on said recording material by a recording head of said printer;
comparing said calibration patterns with said reference patterns, to select among from said reference patterns a density grade that is approximate to an actual density of said calibration pattern; and
adjusting print densities of said recording head on the basis of a difference between a density value of said selected density grade and a set density value used for printing said calibration patterns.

2. A calibration method for a printer, as claimed in claim 1, wherein said calibration patterns are compared to said reference patterns through visual inspection.

3. A calibration method for a printer, as claimed in claim 1, further comprising a step of inputting data of said selected density grade in said printer, wherein said printer adjusts the print densities of said recording head automatically based on said input data.

4. A calibration method for a printer, as claimed in claim 1, wherein density numbers indicating the respective density grades of said reference patterns are printed in correspondence with said reference patterns, and a corresponding one of said density numbers is input as said data of said selected density grade.

5. A calibration method for a printer, as claimed in claim 1, wherein said reference patterns are printed in the same method as said calibration patterns by a reference printer or a marking device, which produces standard print densities.

6. A calibration method for a printer, as claimed in claim 1, wherein said reference patterns are printed as a gradation scale having continuous density grades.

7. A calibration method for a printer, as claimed in claim 1, wherein said recording material is a roll of a long web of recording material, and said reference patterns are previously printed on a leading end of said roll, whereas said calibration patterns are printed in the vicinity of said reference patterns immediately after said roll of recording material is set in said printer.

8. A calibration method for a printer, as claimed in claim 7, wherein said leading end of said roll having said reference patterns and said calibration patterns printed thereon is a marginal portion outside an image recording area, said marginal portion being determined to be cut and thrown away.

9. A calibration method for a printer, as claimed in claim 1, wherein said calibration patterns are printed so as to border said reference patterns.

10. A calibration method for a printer, as claimed in claim 1, wherein said printer is a color printer that produces a full-color image by printing different colors on said recording material, and said reference patterns and said calibration patterns are printed for each color, and compared color by color, to adjust print densities of said recording head color by color.

11. A calibration method for a printer, as claimed in claim 10, wherein said recording material is a color heat sensitive recording paper having at least three coloring layers formed atop another on a base material, said coloring layers developing individual colors in different temperature ranges from one another, and said recording head is a thermal head that applies heat energy of a different amount to each individual heat sensitive coloring layer, to cause said heat sensitive coloring layers sequentially to develop the individual colors.

12. A printer comprising:
a recording head for printing images on a recording material;
a head driver for driving said recording head based on printing data;
a calibration data generator for outputting specified printing data to said head driver, for printing calibration patterns at a constant density adjacently to reference patterns, said reference patterns being previously printed on said recording material and representing a number of density grades;
an input device for inputting data of one of said density grades that is selected as an approximate density to an actual density of said calibration patterns from among said reference patterns; and
a density adjusting device for adjusting print densities of said recording head on the basis of said input data.

13. A printer as claimed in claim 12, wherein said density adjusting device adjusts print densities of said recording head on the basis of a difference between an optical density value of said selected density grade and a set optical density value of said specified printing data generated from said calibration data generator.

14. A printer as claimed in claim 13, wherein said printer is a color thermal printer using as said recording material a color heat sensitive recording paper having at least three coloring layers developing individual colors in different temperature ranges from one another, said coloring layers being formed atop another on a base material, and said recording head is a thermal head that applies heat energy of a different amount to each individual heat sensitive coloring layer, to cause said heat sensitive coloring layers sequentially to develop the individual colors, wherein said reference patterns and said calibration patterns are printed in the respective colors, to permit selecting an approximate density grade to an actual density of each color of said calibration patterns, and wherein said selected density grades of the respective colors are input through said input device, so said density adjusting device adjusts print densities color by color.

15. A recording material characterized by having reference patterns previously printed outside an image recording area in which images are to be printed by a printer, said reference patterns representing a number of density grades.

16. A recording material as claimed in claim 15, wherein said recording material is a roll of a long web of recording material, and said reference patterns are printed on a leading end that is cut and thrown away after the printing in said image recording area.

17. A recording material as claimed in claim 15, wherein said reference patterns are printed as a gradation scale having continuous density grades.

18. A recording material as claimed in claim 15, wherein said reference patterns are printed for respective colors recordable on said recording material.

19. A recording material as claimed in claim 18, wherein said recording material is a color heat sensitive recording paper having at least three heat sensitive coloring layers formed atop another on a base material, said coloring layers developing different colors from one another.
